(19) United States
(12) Patent Application Publication
(10) Pub. No.: US 2026/0306914 A1
(43) Pub. Date: Oct. 8, 2026

(54) MAGNETIC BUCKET STAND FOR USE WITH A PLASTIC BUCKET

(71) Applicant: Alberto Layton, Kingwood, TX (US)

(72) Inventor: Alberto Layton, Kingwood, TX (US)

(21) Appl. No.: 19/264,382

(22) Filed: Jul. 9, 2025

Related U.S. Application Data
(60) Provisional application No. 63/784,328, filed on Apr. 7, 2025.

(51) Int. Cl. A63B 47/00; A63B 102/18

(52) U.S. Cl. CPC A63B 47/00; A63B 2102/18; A63B 2209/08; A63B 2210/50

(57) ABSTRACT

A magnetic bucket stand includes a tripod having a chassis, three legs connected to the chassis, and a threaded bolt extending upward from the chassis; a rigid linear shaft having, a first end having internal threads and a second end, wherein the internal threads are threadably securable to the threaded bolt of the tripod; a rigid flat platform made of a ferromagnetic material attached to the second end of the rigid linear shaft; and a permanent magnet having a first flat side. A plastic bucket may be securely supported atop the platform with the first flat side of the permanent magnet positioned against a bottom inside surface of the plastic bucket and the platform positioned against a bottom outside surface of the plastic bucket such that there is magnetic attraction between the permanent magnet and the platform with the bottom of the plastic bucket held therebetween.

### BACKGROUND

The present disclosure relates to methods and apparatus for elevating a bucket for easy access to the contents of the bucket from a standing position.

### BACKGROUND OF THE RELATED ART

A bucket of softballs or baseballs is an essential tool for conducting effective batting practice. It allows coaches or pitchers to deliver a continuous stream of pitches without frequent interruptions to retrieve balls, maximizing practice time and maintaining a steady rhythm for the batter. The bucket holds a sufficient quantity of balls for players to work on timing, swing mechanics, and pitch recognition in a repetitive and focused manner. Whether used in a cage or on the field, the bucket ensures a smooth and efficient practice session, supporting skill development through consistent repetition. For example, a common 6 gallon bucket may hold up to 48 baseballs or 24 softballs.

However, with the bucket set at ground level, the pitcher must bend over to grab one of the balls prior to each pitch. Muscle fatigue from repetitive bending over to pick up softballs or baseballs during batting practice typically sets in gradually, often targeting the lower back, hamstrings, and hip flexors. With each repetition, these muscles are engaged in stabilizing the body and supporting the movement, especially if proper lifting technique is not used. Over time, the constant flexion of the spine and strain on the posterior chain can lead to stiffness, a burning sensation, and a noticeable decrease in strength or responsiveness. This fatigue can make the movement feel slower and less controlled, increasing the risk of strain or injury, particularly in the lumbar region. The repetitive nature of the action, combined with limited recovery between bends, compounds the physical stress on these muscle groups. Often, the pitcher may be a coach or parent that is not necessarily in a physical condition to withstand this physical stress without injury or soreness.

To avoid a user having to repetitively bend over to grab another ball from a bucket set directly on the ground, the bucket of balls may be set on a chair or placed in a ball stand basket. For example, the bucket may be set down into the ball stand basket such that the sides of the basket wrap around a perimeter side of the bucket. The sides of the basket keep the bucket upright and prevent the bucket from shifting side-to-side or falling over. However, the basket and the bucket must have specific compatible diameters for this to work.

### BRIEF SUMMARY

Some embodiments provide an apparatus comprising: a tripod having a chassis, three legs connected to the chassis, and a threaded bolt extending upward from the chassis at the center of the tripod; a rigid linear shaft having a central axis, a first end having internal threads and a second end, wherein the internal threads are threadably securable to the threaded bolt of the tripod; a rigid flat platform made of a ferromagnetic material attached to the second end of the rigid linear shaft; and a permanent magnet having a first flat side, wherein a plastic bucket may be securely supported atop the rigid flat platform with the first flat side of the permanent magnet positioned against a bottom inside surface of the plastic bucket and the rigid flat platform positioned against a bottom outside surface of the plastic bucket such that there is magnetic attraction between the permanent magnet and the rigid flat platform with the bottom of the plastic bucket held therebetween.

Some embodiments provide a kit comprising: a tripod having a chassis, three legs connected to the chassis, and a threaded bolt extending upward from the chassis at the center of the tripod; a rigid linear shaft having a central axis, a first end having internal threads and a second end, wherein the internal threads are threadably securable to the threaded bolt of the tripod; a rigid flat platform made of a ferromagnetic material attached to the second end of the rigid linear shaft; and a permanent magnet having a first flat side, wherein a plastic bucket may be securely supported atop the rigid flat platform with the first flat side of the permanent magnet positioned against a bottom inside surface of the plastic bucket and the rigid flat platform positioned against a bottom outside surface of the plastic bucket such that there is magnetic attraction between the permanent magnet and the rigid flat platform with the bottom of the plastic bucket held therebetween.

Some embodiments provide a method comprising: threadably connecting a tripod to a first end of a rigid linear shaft, wherein the rigid linear shaft includes a second end attached to a rigid flat platform made of a ferromagnetic material; setting the tripod on a support surface such that the rigid linear shaft extends upward away from the support surface and the rigid flat platform is generally horizontal; positioning a permanent magnet inside a plastic bucket so that a first flat side of the permanent magnet is positioned against a bottom inside surface of the plastic bucket; setting the plastic bucket on the rigid flat platform so that a bottom outside surface of the plastic bucket rests on the rigid flat platform and there is magnetic attraction between the permanent magnet and the rigid flat platform with the bottom of the plastic bucket therebetween such that the plastic bucket is secured in position on the rigid flat platform; and adding and removing balls from the bucket.

### BRIEF DESCRIPTION OF THE SEVERAL VIEWS OF THE DRAWINGS

FIG. 1 is a perspective view of the magnetic bucket stand.

FIG. 2A is a perspective view of a tripod base in an open position.

FIG. 2B is a perspective view of the tripod base in a collapsed or folded position.

FIG. 2C is a bottom view of the central hub of the tripod base.

FIG. 3A is a perspective view of a shaft having a lower end with a threaded hole for connecting to the tripod base and an upper end securing a platform for engaging a plastic bucket.

FIG. 3B is a perspective view of a platform having a bolt for connecting to the upper end of the shaft.

FIG. 3C is a cross-sectional view of the first end of the shaft as shown in FIG. 3A or the second end of the shaft as shown in FIG. 3B.

FIG. 4A is a top perspective view of a magnet used to secure a plastic bucket to a top of the stand.

FIG. 4B is a bottom view of the magnet of FIG. 4A.

FIG. 5A is a partial perspective view of the platform at the upper end of the shaft supporting a bottom of a plastic bucket.

FIG. 5B is a top view of a plastic bucket filled with balls and having the magnet positioned against the bottom of the plastic bucket for forming a magnetic attraction with the platform.

FIG. 5C is a perspective view of the magnetic bucket stand securing a plastic bucket.

### DETAILED DESCRIPTION

Some embodiments provide an apparatus comprising: a tripod having a chassis, three legs connected to the chassis, and a threaded shaft extending upward from the chassis at the center of the tripod; a rigid linear shaft having a central axis, a first end having internal threads and a second end, wherein the internal threads are threadably securable to the threaded bolt of the tripod; a rigid flat platform made of a ferromagnetic material attached to the second end of the rigid linear shaft; and a permanent magnet having a first flat side, wherein a plastic bucket may be securely supported atop the rigid flat platform with the first flat side of the permanent magnet positioned against a bottom inside surface of the plastic bucket and the rigid flat platform positioned against a bottom outside surface of the plastic bucket such that there is magnetic attraction between the permanent magnet and the rigid flat platform with the bottom of the plastic bucket held therebetween.

Embodiments include a tripod for supporting the shaft, platform, magnet, bucket and any contents of the bucket. The three points of contact between a tripod and a supporting surface is more stable than a four-legged stand on uneven surfaces because three points are always guaranteed to define a plane, ensuring stability, whereas four points may not all touch the ground simultaneously on uneven terrain, causing wobbling. In one option, the preferred tripod has a diameter (i.e., it's footprint on the ground when fully deployed) between 10 and 18 inches, such as between 12 and 14 inches and most preferably about 13 inches. The tripod includes a central chassis or spider that connects the three legs and forms a platform for connecting with the shaft. In some embodiments, the chassis forms a flat top surface with a threaded shaft (bolt) extending upward perpendicular to a top surface of the platform, wherein the threaded shaft or bolt may be used for firmly connecting the shaft to the tripod. The legs and chassis of the tripod may be made of metal and/or rigid plastic. The tripod is also preferably foldable, such as by pivotally connecting each leg to the chassis.

Embodiments of the rigid linear shaft may be made with a section of tubular pipe. The tubular pipe may be made from a metal, such as steel, or a rigid plastic. In one option, the tubular pipe may have a diameter between ½ and 1 inch, such as about ¾ inch. In another option, the tubular pipe may have a length between about 10 and 24 inches, such as about 16 to 18 inches. In one specific example, the shaft may be formed using a 17 inch long section of ¾ inch diameter steel pipe. The threaded fastener at the bottom end of the shaft may be formed by welding or otherwise securing a threaded nut into the bottom end of the tubular pipe. For example, a standard washer and nut may be welded into the bottom end of a ¾ diameter steel pipe. The nut (threaded fastener) at the lower end of the shaft should be alignable with the bolt (threaded fastener) on the top of the tripod so that the shaft and tripod may be securely connected by a threaded connection.

Embodiments of the platform or base plate may be permanently or temporarily secured to the top end of the shaft. For example, the circular platform may be permanently secured to the top end of the shaft by welding or may be temporarily secured to the top end of the shaft with a threaded fastener. In one option, the shaft may include the same internal threads at each end and the circular platform may include a bolt having the same threads as the bolt on the tripod. As such, the shaft may be secured between the tripod and the platform in either orientation and both the tripod and platform may be removed for storage. Without limitation, the platform may have a diameter or lateral dimension between 3 and 6 inches, such as a circular platform having a diameter of about 4 inches or a square platform having sides that are about 4 inches. A preferred platform may be formed from low carbon steel, may have a plain finish, and may have a smooth surface and edges without burrs (i.e., no sharp edges). In one option, the rigid flat platform may have a thickness between 3/16 and ½ inch, such as 7/32 inch. In one specific embodiment, the platform is made from steel having a thickness of 7/32 inch (5.6 mm), a diameter of 4 inches (100 mm) and a weight of about 12.6 oz (357 g). The platform is preferably made with a ferromagnetic material (i.e., a material that is strongly attracted to the magnetic field of a permanent magnet), such as steel.

In some embodiments, the rigid flat platform may be welded to the second (upper) end of the rigid linear shaft. However, in other embodiments, the rigid flat platform may include a threaded shaft (bolt) that is threadably securable to internal threads (nut) in the second end of the shaft. In the latter embodiments, the rigid flat platform may be threadably secured to the shaft and removed when not in use. The internal threads in the second end of the shaft may be formed in the same manner as the internal threads in the first end of the shaft, such that the internal threads (nut) in either end of the shaft may be connected to the externally threaded shaft (bolt) on either of the tripod or the rigid flat platform.

Embodiments of the permanent magnet provide a strong magnetic pull force to keep the bucket and its contents, such as a bunch of baseballs or softballs, from separating from the platform during use. For example, the magnetic pull force (magnetic attraction force) may be about 500 to 1000 pounds when the first flat side of permanent magnet is in direct contact with the rigid flat platform, most preferably about 800 pounds. The magnetic pull force is the amount of force, typically measured in pounds or kilograms, that is required to pull the magnet straight away from a ferromagnetic material, like a thick steel plate (i.e., pull the magnet from the ferromagnetic material in a direction perpendicular to the interface between the magnet and the ferromagnetic material). It should be recognized that since magnetic attraction is a function of distance between two object, the actual magnetic attraction between the permanent magnet and the rigid flat platform will be reduced when the bottom of the plastic bucket is positioned there between. Without limitation, the magnet may be circular with a diameter of from 3 to 4 inches, with a preferred diameter of about 3 inches. Optionally, both the rigid flat platform and the permanent magnet are circular with diameters between 3 and 5 inches. Furthermore, the magnet may include a handle to assist with positioning and/or removing the magnet. For example, the permanent magnet may include a second side opposite the first flat side and a handle extending from the second side.

However, once positioned in the bottom of the plastic bucket, the magnet and plastic bucket may be handled together as a unit. For example, the magnet may be set in the bottom of the bucket and a collection of balls placed on top of the magnet. Then, the plastic bucket may be set onto the platform and the magnet will be automatically attracted to the ferromagnetic platform. Later, the magnetic attraction force between the magnet and the platform may be overcome by tilting the plastic bucket relative to the platform and shaft. The plastic bucket provides a long lever arm that makes it easier to overcome the magnetic attraction force than directly grasping and tilting the handle on the magnet at the bottom of the plastic bucket.

Embodiments of the magnetic bucket stand may be used with a plastic bucket. Plastic is not a ferromagnetic material and does not participate in any magnetic attraction. However, the thickness of the bottom of the plastic bucket maintains a small distance of separation between the permanent magnet and the rigid flat platform, which reduces the effective strength of the magnetic attraction between the permanent magnet and the rigid flat platform. The plastic bucket may be any plastic bucket, including a standard plastic bucket. Without limitation, a standard plastic bucket, such as a 3.5-gallon, 5-gallon or 10-gallon pail, is a versatile container with a cylindrical body, an optional handle, and an optional lid. Plastic buckets may be made from high-density polyethylene (HDPE), which is known for its durability. Common dimensions of a 5-gallon plastic bucket may have a height between 13 and 15 inches and a diameter between 11 and 12 inches. However, it is an advantage of the present embodiments that plastic buckets with non-standard dimensions may also be used. For example, the plastic bucket will have a sidewall and the plastic bucket may be secured in a position atop the rigid flat platform without any element of the platform extending around the sidewall of the plastic bucket. Accordingly, the platform and the permanent magnet are able to secure any plastic bucket having a flat bottom and a diameter that is greater than the diameter of the rigid flat platform and the diameter of the permanent magnet. In one option, a 6-gallon bucket may have an appropriate size to include 48 baseballs or 36 softballs.

Embodiments of the permanent magnet may be a neodymium magnet. A neodymium magnet is engineered to produce a high magnetic attraction force. For example, a magnet formed with a 3 inch CNC-machined steel base that is embedded with a high-powered neodymium magnet may offer an impressive 800 pounds of pulling force.

In one specific embodiment, the platform and the magnet have the same shape and a similar diameter. However, the platform may be larger than the magnet to provide stability for the plastic bucket and so that the magnet does not have to be perfectly aligned or centered with the platform in order to achieve a high degree of the potential magnetic attraction therebetween.

The stand works without being dependent upon the bucket diameter, but the bucket may have a diameter of about 8-12 inches. Embodiments of the magnetic bucket stand do not have any portion of the apparatus that extends around a perimeter of the plastic bucket. By contrast, some fold out stands are designed with perimeter supports that extend around the sides of a bucket and are designed for a bucket having a particular diameter, such that a bucket having a greater diameter will not fit inside the supports on the fold out stand and a bucket having a smaller diameter will sit loosely without making contact with the perimeter supports.

Some embodiments provide a kit comprising: a tripod having a chassis, three legs connected to the chassis, and a threaded bolt extending upward from the chassis at the center of the tripod; a rigid linear shaft having a central axis, a first end having internal threads and a second end, wherein the internal threads are threadably securable to the threaded bolt of the tripod; a rigid flat platform made of a ferromagnetic material attached to the second end of the rigid linear shaft; and a permanent magnet having a first flat side, wherein a plastic bucket may be securely supported atop the rigid flat platform with the first flat side of the permanent magnet positioned against a bottom inside surface of the plastic bucket and the rigid flat platform positioned against a bottom outside surface of the plastic bucket such that there is magnetic attraction between the permanent magnet and the rigid flat platform with the bottom of the plastic bucket held therebetween.

In some embodiments, the kit may further comprise the plastic bucket, wherein the plastic buck is a standard plastic bucket having a diameter that is greater than the diameter of the rigid platform and the diameter of the permanent magnet. Because the kit and/or apparatus does not have any component that extends around a sidewall of the plastic bucket, the kit and/or apparatus may be used with plastic buckets having a wide range of diameters without affecting the stability of the plastic bucket on the platform. In one option, the plastic bucket may be filled with softballs and/or baseballs. Furthermore, the kit embodiments may include any aspect, feature, component or construction of the apparatus and may be used in accordance with any method or operation described herein.

Some embodiments provide a method comprising: threadably connecting a tripod to a first end of a rigid linear shaft, wherein the rigid linear shaft includes a second end attached to a rigid flat platform made of a ferromagnetic material; setting the tripod on a support surface such that the rigid linear shaft extends upward away from the support surface and the rigid flat platform is generally horizontal; positioning a permanent magnet inside a plastic bucket so that a first flat side of the permanent magnet is positioned against a bottom inside surface of the plastic bucket; setting the plastic bucket on the rigid flat platform so that a bottom outside surface of the plastic bucket rests on the rigid flat platform and there is magnetic attraction between the permanent magnet and the rigid flat platform with the bottom of the plastic bucket therebetween such that the plastic bucket is secured in position on the rigid flat platform; and adding and removing balls from the bucket.

In some embodiments, the tripod, shaft and platform elevate the plastic bucket above the support surface so that a user can reach the balls in the bucket without bending over. For example, the platform may be about 18-24 inches tall, most preferably 19 inches tall, so that magnetic bucket stand positions the top edge of the bucket at about waist level for an adult of average height.

In some embodiments, the method may further comprise removing the plastic bucket from the rigid flat platform by grasping the top of the plastic bucket, such as the bail handle, and tilting the plastic bucket relative to the rigid flat platform without removing the permanent magnet from the plastic bucket. In other words, if the bucket stand will be used with the same plastic bucket from one use to another, then the permanent magnet can stay in the bottom of the plastic bucket with the softballs or baseballs on top of the permanent magnet between uses and during subsequent uses. Furthermore, the method may further comprise storing the permanent magnet in the plastic bucket along with a plurality of the balls between instances that the tripod, shaft and platform are used to elevate the plastic bucket. The rigid stand itself can be quickly and easily disassembled into pieces that fit within a backpack with plenty of room for additional equipment, such as a softball glove or baseball glove.

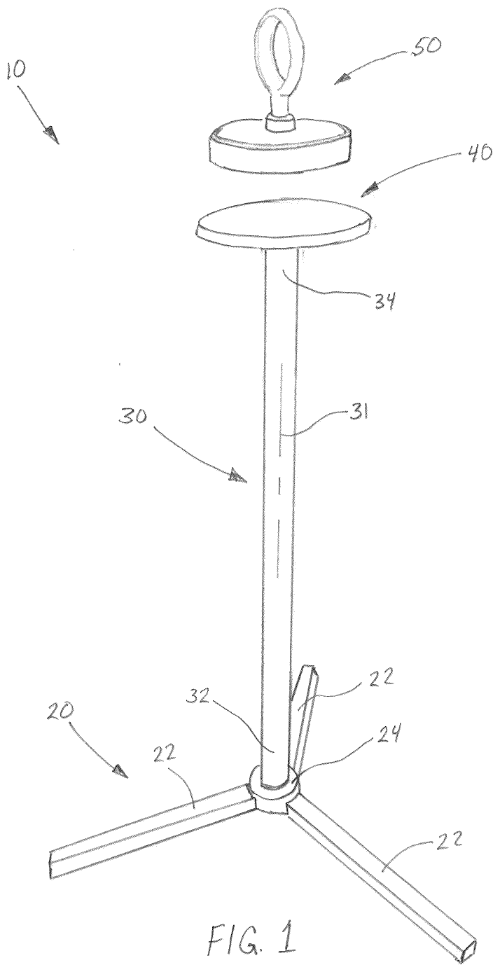

FIG. 1 is a perspective view of the magnetic bucket stand 10. The magnetic bucket stand 10 includes a tripod 20, a rigid linear shaft 30, a rigid flat platform 40 and a permanent magnet 50. The tripod 20 includes three legs 22 connected to a chassis 24. The rigid linear shaft 30 has a central axis 31, a first (lower) end 32, and a second (upper) end 34. The first (lower) end 32 of the shaft 30 connects with the chassis 24 and the second (upper) end 34 of the shaft 30 is attached to or connected with the rigid flat platform 40. The permanent magnet 50 forms a magnetic attraction (pull force) with the rigid flat platform 40, which is made with a ferromagnetic material such as steel, when the magnet 50 is brought into a proximate face-to-face position relative to the platform 40.

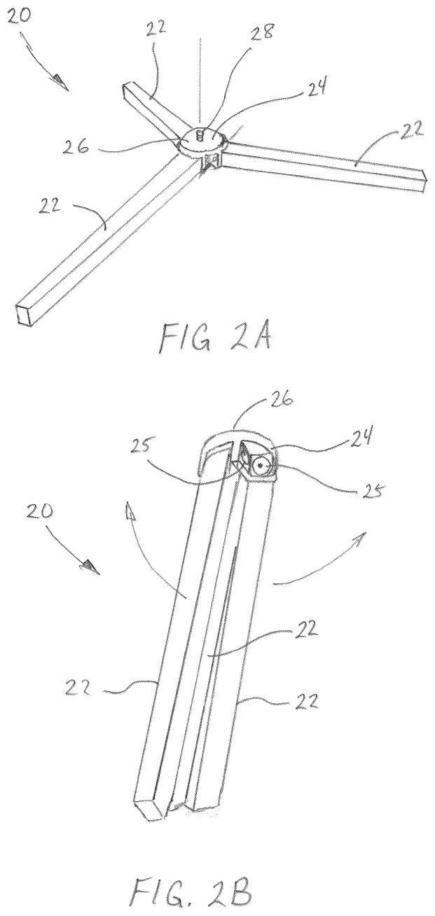

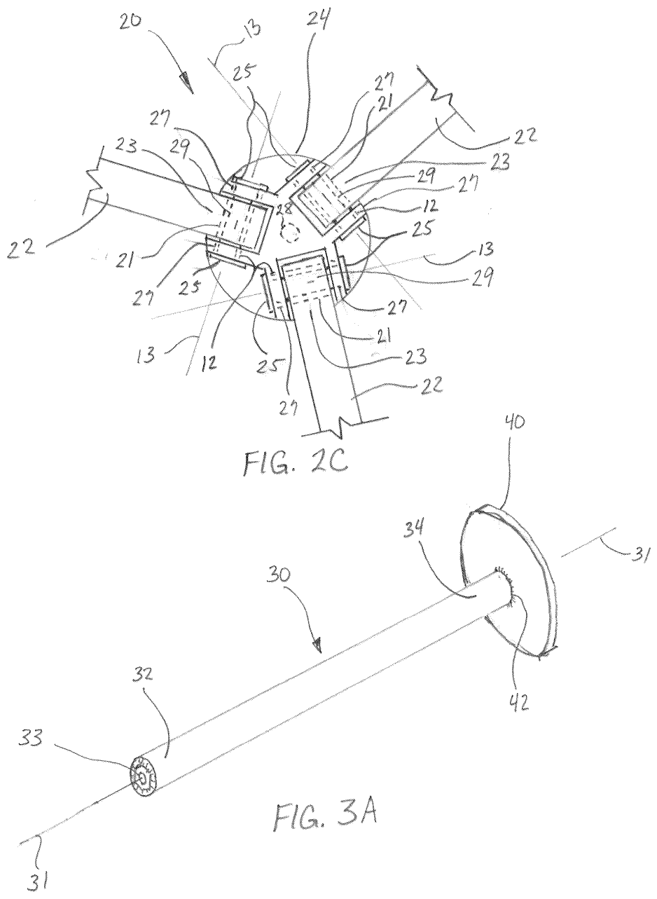

FIG. 2A is a perspective view of the tripod 20 in an open condition or position. The three legs 22 are the same size and extend radially outward from the central chassis 24 at equal angular spacings (approximately 120 degrees apart). The chassis 24 may pivotally secure a proximal end of each leg 22 as shown in more detail below. With a distal end of each leg 22 resting on a support surface such as a softball or baseball field, the chassis 24 has a flat top surface 26 with a threaded shaft (bolt) extending upward perpendicular to the flat top surface 26. Without limitation, the tripod 20 may be made of metal and the threaded shaft 28 may be the threaded end of a ¼ inch diameter bolt. In one option, the flat top surface 26 may be elevated about 4.33 inches about the support surface.

FIG. 2B is a perspective view of the tripod (or tripod base) 20 in a collapsed or folded position. Accordingly, the three legs 22 are now close together and nearly parallel to take up less space during storage or nonuse. Each leg 22 is pivotally secured to the chassis 24. A rivet or head 25 may form part of a pivot attachment for each of the legs 22 as shown in greater detail in FIG. 2C.

FIG. 2C is a bottom view of the central chassis 24 of the tripod 20. Each of the three legs 22 has a proximal end 23 that is pivotally secured between a pair of brackets 27 that are part of the chassis 24. Each pair of brackets 27 are radially directed and open radially outward to receive a proximal end 23 of one of the legs 22. The proximal end 23 of each leg 22 includes a lateral hole 21 that receives a pivot pin 29. Each pivot pin 29 extends through a hole 21 through one of the legs 22, then through the holes 12 in the pair of brackets 27 and then are secured to rivets or heads 25 on each end of the pivot pin 29. Accordingly, each leg 22 can pivot about the axis 13 defined by the pivot pin 29. Although this bottom view does not show the flat top surface 26 of the threaded shaft 28 (see FIG. 2A), the position of the threaded shaft 28 is illustrated in dashed lines.

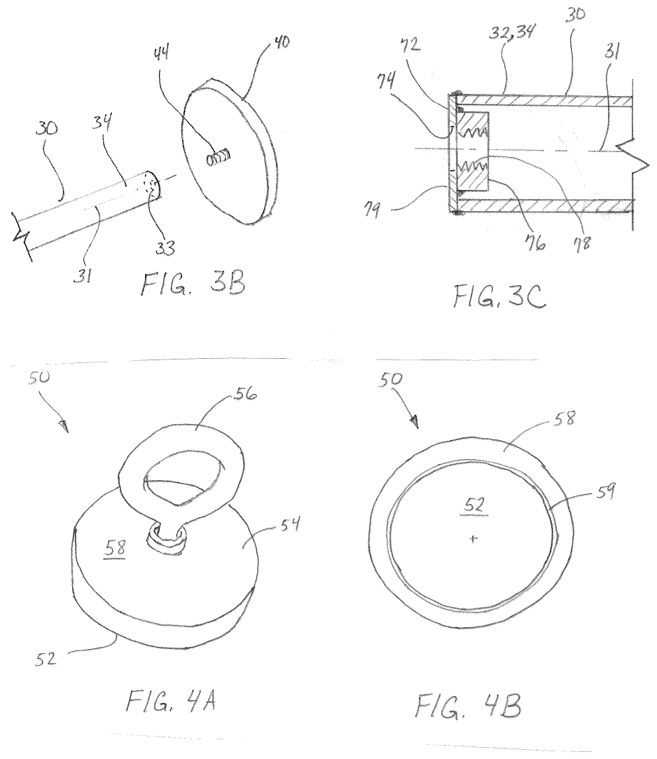

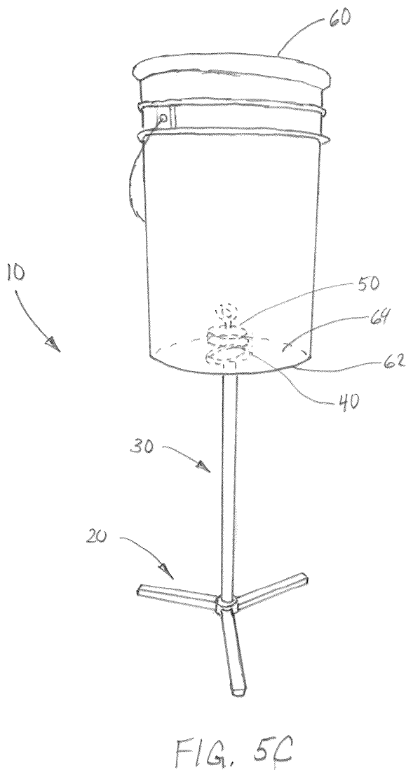

FIG. 3A is a perspective view of the shaft 30 having a first (lower) end 32 with a threaded hole 33 for connecting to the threaded shaft 28 of the tripod 20 (see FIG. 2A). The shaft 30 also has a second (upper) end 34 securing the platform 40 for engaging a plastic bucket (not shown; but see FIG. 5A). The platform 40 is shown welded to the second end 34 of the shaft 30, such as with a weld 42 around the perimeter of the second end 34 and connecting to the bottom side of the platform 40, so that the flat rigid platform is substantially perpendicular to the central axis 31 of the shaft 30.

FIG. 3B is a perspective view of the platform 40 having a threaded shaft (bolt) 44 for connecting to the second (upper) end 34 of the shaft 30. For this optional embodiment, the second (upper) end 34 may include a threaded hole (nut) 33 as also shown in FIG. 3A. Accordingly, the threaded shaft 44 axially aligns with the threaded hole 33 and may be threadably engaged to secure the platform 40 to the second end 34 of the shaft 30.

FIG. 3C is a cross-sectional view of the first end 32 of the shaft 30 as shown in FIG. 3A or the second end 34 of the shaft 30 as shown in FIG. 3B. A threaded nut 76 includes internal threads 78 and is welded to a metal washer 72. The metal washer 72 is subsequently welded to the open end 32, 34 of the shaft 30, leaving a central hole 74. Accordingly, the externally threaded shaft (bolt) 28 of the tripod 20 and/or the threaded shaft (bolt) 44 of certain embodiments of the platform 40 may be threadably secured to the internally threaded hole (nut) 76. The metal washer 72 preferably has a flat outer surface 79 so that, when the threads are manually tightened, the shaft 30 will form a secure connection against the upper surface of the tripod chassis 24 or the bottom surface of the platform 40 in the embodiment of FIG. 3B.

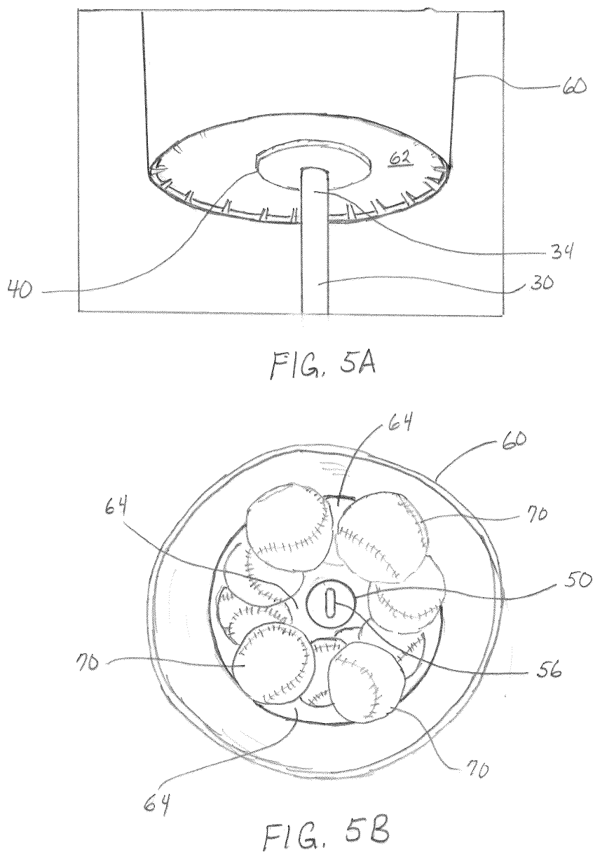

FIG. 4A is a top perspective view of the magnet 50 used to secure a plastic bucket to a top platform 40 of the magnetic bucket stand 10 (see FIG. 1). The magnet 50 has a first flat side 52, a second side 54 opposite the first side 52, and a handle 56 extending from the second side 54. Optionally, the second side may be formed by a machined steel housing or base 58, which may cover the top and sides of a neodymium rare earth magnet 52 secured within the steel housing 58.

FIG. 4B is a bottom view of the magnet of FIG. 4A. The circular neodymium rare earth magnet 52 is centered within the steel housing 58. Optionally, a thin layer of adhesive resin 59 may be applied between the magnet 52 and the steel housing 58.

FIG. 5A is a partial perspective view of the platform 40 at the upper end 34 of the shaft 30 supporting the outside bottom surface 62 of a plastic bucket 60. While the platform 40 may seem quite small or narrow relative to the size or diameter of the outside bottom surface 62 of the plastic bucket 60, the magnetic attraction between the magnet 50 (not shown; see FIG. 5B) and the platform 40 prevent the plastic bucket 60 and its contents from falling off the platform 40.

FIG. 5B is a top view of the plastic bucket 60 filled with balls 70 (typically, softballs and/or baseballs) and having the magnet 50 positioned against the inside bottom surface 64 of the plastic bucket 60 for forming a magnetic attraction with the platform 40 (not shown; see FIG. 5A and FIG. 1). The flat side 52 of the magnet 50 (see FIG. 4B) is positioned flush against the inside bottom surface 64 of the plastic bucket 60 and, as shown in FIG. 5A, the platform 40 is flush against the outside bottom surface 62 of the bucket 60. Accordingly, a strong magnetic attraction force is formed between the magnet 50 and the platform 40 such that the bottom of the bucket 60 is tightly gripped between the magnet 50 and the platform 40. This tight gripping force prevents the bucket 60 and the balls 70 from easily tipping off the platform 40 despite the narrow dimensions of the platform 40 and magnet 50 relative to the bottom of the bucket 60.

FIG. 5C is a perspective view of the magnetic bucket stand 10 securing the plastic bucket 60 in an elevated position where a user can reach the contents, such as softballs or baseballs, within the bucket 60 without bending over or at least with a reduced degree of bending. As in FIG. 1, and consistent with the other Figures, the magnetic bucket stand 10 includes the tripod 20, the rigid linear shaft 30, the rigid flat platform 40 and the permanent magnet 50. The plastic bucket 60 has a thin bottom panel (i.e., the material between the inside bottom surface 64 and the outside bottom surface 62) being gripped between the magnet 50 and the platform 40 consistent with FIGS. 5A-B.

The terminology used herein is for the purpose of describing particular embodiments only and is not intended to limit the scope of the claims. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, components and/or groups, but do not preclude the presence or addition of one or more other features, integers, steps, operations, elements, components, and/or groups thereof. The terms “preferably,” “preferred,” “prefer,” “optionally,” “may,” and similar terms are used to indicate that an item, condition or step being referred to is an optional (not required) feature of the embodiment.

The corresponding structures, materials, acts, and equivalents of all means or steps plus function elements in the claims below are intended to include any structure, material, or act for performing the function in combination with other claimed elements as specifically claimed. Embodiments have been presented for purposes of illustration and description, but it is not intended to be exhaustive or limited to the embodiments in the form disclosed. Many modifications and variations will be apparent to those of ordinary skill in the art after reading this disclosure. The disclosed embodiments were chosen and described as non-limiting examples to enable others of ordinary skill in the art to understand these embodiments and other embodiments involving modifications suited to a particular implementation.

What is claimed is:

1. An apparatus, comprising:
a tripod having a chassis, three legs connected to the chassis, and a threaded bolt extending upward from the chassis at the center of the tripod;
a rigid linear shaft having a central axis, a first end having internal threads and a second end, wherein the internal threads are threadably securable to the threaded bolt of the tripod;
a rigid flat platform made of a ferromagnetic material attached to the second end of the rigid linear shaft; and
a permanent magnet having a first flat side, wherein a plastic bucket may be securely supported atop the rigid flat platform with the first flat side of the permanent magnet positioned against a bottom inside surface of the plastic bucket and the rigid flat platform positioned against a bottom outside surface of the plastic bucket such that there is magnetic attraction between the permanent magnet and the rigid flat platform with the bottom of the plastic bucket held therebetween.

2. The apparatus of claim 1, wherein the rigid flat platform and the permanent magnet are both circular with a diameter of between 3 and 4 inches.

3. The apparatus of claim 2, wherein the ferromagnetic material is steel, and the rigid flat platform has a thickness between 3/16 and ½ inch.

4. The apparatus of claim 3, wherein the magnet provides more than about 500 pounds of magnetic pull force when the first flat side of permanent magnet is in direct contact with the rigid flat platform.

5. The apparatus of claim 4, wherein the magnet is a neodymium magnet.

6. The apparatus of claim 1, wherein the rigid linear shaft has a length between 10 and 18 inches.

7. The apparatus of claim 1, wherein there is no portion of the apparatus that extends around a perimeter of the plastic bucket.

8. The apparatus of claim 1, wherein the tripod has foldable legs.

9. The apparatus of claim 1, wherein the three legs are pivotally connected to the chassis, and wherein the threaded bolt extends upward from the center of the chassis.

10. The apparatus of claim 1, wherein the rigid flat platform is welded to the second end of the rigid linear shaft.

11. The apparatus of claim 1, wherein the rigid flat platform includes a threaded bolt that is threadably securable to internal threads in the second end of the shaft.

12. The apparatus of claim 1, wherein the permanent magnet includes a second side opposite the first flat side and a handle extending from the second side.

13. The apparatus of claim 1, wherein the plastic bucket has a sidewall, and wherein the plastic bucket is secured in position atop the rigid flat platform without any element of the platform extending around the sidewall of the plastic bucket.

14. The apparatus of claim 13, wherein the platform and the permanent magnet are able to secure any unmodified standard plastic bucket having a diameter that is greater than the diameter of the rigid flat platform and the diameter of the permanent magnet.

15. A kit, comprising:
a tripod having a chassis, three legs connected to the chassis, and a threaded bolt extending upward from the chassis at the center of the tripod;
a rigid linear shaft having a central axis, a first end having internal threads and a second end, wherein the internal threads are threadably securable to the threaded bolt of the tripod;
a rigid flat platform made of a ferromagnetic material attached to the second end of the rigid linear shaft; and
a permanent magnet having a first flat side, wherein a plastic bucket may be securely supported atop the rigid flat platform with the first flat side of the permanent magnet positioned against a bottom inside surface of the plastic bucket and the rigid flat platform positioned against a bottom outside surface of the plastic bucket such that there is magnetic attraction between the permanent magnet and the rigid flat platform with the bottom of the plastic bucket held therebetween.

16. The kit of claim 15, further comprising:
the plastic bucket, wherein the plastic buck is a standard plastic bucket having a diameter that is greater than the diameter of the rigid platform and the diameter of the permanent magnet.

17. The kit of claim 16, wherein the plastic bucket is filled with softballs and/or baseballs.

18. A method, comprising:
threadably connecting a tripod to a first end of a rigid linear shaft, wherein the rigid linear shaft includes a second end attached to a rigid flat platform made of a ferromagnetic material;
setting the tripod on a support surface such that the rigid linear shaft extends upward away from the support surface and the rigid flat platform is generally horizontal;
positioning a permanent magnet inside a plastic bucket so that a first flat side of the permanent magnet is positioned against a bottom inside surface of the plastic bucket;
setting the plastic bucket on the rigid flat platform so that a bottom outside surface of the plastic bucket rests on the rigid flat platform and there is magnetic attraction between the permanent magnet and the rigid flat platform with the bottom of the plastic bucket therebetween such that the plastic bucket is secured in position on the rigid flat platform; and
adding and removing balls from the bucket.

19. The method of claim 18, wherein the tripod, shaft and platform elevate the plastic bucket above the support surface so that a user can reach the balls in the bucket without bending over.

20. The method of claim 18, further comprising:
removing the plastic bucket from the rigid flat platform by grasping the top of the plastic bucket and tilting the plastic bucket relative to the rigid flat platform without removing the permanent magnet from the plastic bucket; and
storing the permanent magnet in the plastic bucket along with a plurality of the balls between instances that the tripod, shaft and platform are used to elevate the plastic bucket.
